(19) United States
(12) Patent Application Publication
(10) Pub. No.: US 2026/0280961 A1
(43) Pub. Date: Sep. 17, 2026

(54) COMMUNICATION METHOD, APPARATUS AND DEVICE AND STORAGE MEDIUM

(71) Applicant: Telefonaktiebolaget LM Ericsson (publ), Stockholm (SE)

(72) Inventors: Daiying LIU, Beijing (CN); Luzhi MA, Beijing (CN)

(21) Appl. No.: 19/471,452

(22) PCT Filed: Apr. 4, 2023
(86) PCT No.: PCT/CN2023/086279

§ 371 Date: Oct. 1, 2025

(51) Int. Cl. H04L 41/0213; H04L 41/046; H04L 43/0823

(52) U.S. Cl. CPC H04L 41/0213; H04L 41/046; H04L 43/0847

(57) ABSTRACT

Embodiments of the present disclosure provide communication methods, communication devices and storage medium. In the method, a configuration is received by a Simple Network Management Protocol (SNMP) agent from a SNMP manager to enable acknowledgements to notifications for a set of object identifiers (OIDs). The set of OIDs is selected from a plurality of OIDs associated with the SNMP agent. A notification for an OID in the set of OIDs is transmitted by the SNMP agent to the SNMP manager. An acknowledgement to the notification from the SNMP manager is monitored for by the SNMP agent.

### TECHNICAL FIELD

The non-limiting and embodiments of the present disclosure generally relate to the technical field of telecommunications, and specifically to communication methods, communication devices and storage medium.

### BACKGROUND

This section introduces aspects that may facilitate a better understanding of the disclosure. Accordingly, the statements of this section are to be read in this light and are not to be understood as admissions about what is in the prior art or what is not in the prior art.

A Simple Network Management Protocol (SNMP) is an application layer protocol that may use a User Datagram Protocol (UDP) port number. The SNMP may be used to monitor a network, detect faults in the network, and configure remote devices to be monitored or managed. A TRAP message, also referred to as a SNMP trap or a trap, is a SNMP message that may be sent from a SNMP agent to a SNMP manager to report a fault event or other events associated with monitored objects. An INFORM message, also referred to as a SNMP inform or an inform, is another type of SNMP messages to notify network faults or events. Different from the TRAP message, the INFORM message requires an acknowledgement from the SNMP manager to guarantee transmission reliability.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As mentioned above, the TRAP message may be sent from a SNMP agent to a SNMP manager to report a fault event or other events associated with monitored objects. However, there is no acknowledgement (ACK) mechanism for the TRAP message, and thus the SNMP agent may not know whether the SNMP manager has received the TRAP message. However, it may be unacceptable to lose some traps if the loss of these traps may cause performance degradation of the network, for example.

Different from the TRAP message, the INFORM message requires an acknowledgement from the SNMP manager to guarantee transmission reliability. However, the frequent transmissions of the INFORM messages may cause a waste of resources such as local memory resources and network transmission resources. Therefore, there is a need for a tradeoff between transmission reliability and resource utilization of the SNMP messages.

To overcome or mitigate at least one of the above-mentioned problems or other problems or provide a useful solution, embodiments of the present disclosure propose communication methods, communication devices and storage medium.

In a first aspect of the present disclosure, there is provided a communication method. In the method, a configuration is received by a SNMP agent from a SNMP manager to enable acknowledgements to notifications for a set of object identifiers (OIDs). The set of OIDs is selected from a plurality of OIDs associated with the SNMP agent. A notification for an OID in the set of OIDs is transmitted by the SNMP agent to the SNMP manager. An acknowledgement to the notification from the SNMP manager is monitored for by the SNMP agent.

In an embodiment, an indication for allowing acknowledgements to notifications for the plurality of OIDs may be transmitted by the SNMP agent to the SNMP manager.

In an embodiment, a notification may be transmitted by the SNMP agent to the SNMP manager to indicate a target event associated with an OID of the plurality of OIDs from a source. A report of a duplicated event associated with the OID of the plurality of OIDs from the source may be monitored for by the SNMP agent within a time period. If the report of the duplicated event is received within the time period, the duplicated event may be ignored by the SNMP agent.

In an embodiment, a report of a target event associated with an OID of the plurality of OIDs may be received by the SNMP agent from a source. A report of a reverse event associated with the OID of the plurality of OIDs from the source may be monitored for by the SNMP agent within a time period. If the report of the reverse event is received within the time period, the target event and the reverse event may be ignored by the SNMP agent. A notification may be transmitted by the SNMP agent, to the SNMP manager to indicate a pair of the target event and the reverse event associated with the OID of the plurality of OIDs from the source.

In an embodiment, if there is no report of the reverse event within the time period, a notification may be transmitted by the SNMP agent to the SNMP manager to indicate the target event associated with the OID of the plurality of OIDs from the source.

In an embodiment, the time period may be determined based on a timer used to monitor for a duplicated event and/or a pair of a target event and a reverse event. A configuration for the timer may be received by the SNMP agent from the SNMP manager.

In an embodiment, the configuration for enabling the acknowledgements to the notifications for the set of OIDs, the indication for allowing the acknowledgements to the notifications for the plurality of OIDs, and/or the configuration for the timer may be communicated via management information base (MIB).

In a second aspect of the present disclosure, there is provided a communication method. In the method, a set of OIDs is selected by a SNMP manager from a plurality of OIDs associated with a SNMP agent. A configuration for enabling acknowledgements to notifications for the set of OID is transmitted by a SNMP manager to the SNMP agent.

In an embodiment, an indication for allowing acknowledgements to notifications for the plurality of OIDs may be received by the SNMP manager from the SNMP agent.

In an embodiment, a configuration for a timer may be transmitted by the SNMP manager to the SNMP agent. The timer may be used to monitor for a duplicated event and/or a pair of a target event and a reverse event.

In an embodiment, a notification may be received by the SNMP manager from the SNMP agent to indicate a pair of a target event and a reverse event associated with an OID of the plurality of OIDs from a source.

In a third aspect of the present disclosure, there is provided a communication device. The communication device comprises a receiving unit configure to receive, from a SNMP manager, a configuration for enabling acknowledgements to notifications for a set of OIDs. The set of OIDs is selected from a plurality of OIDs associated with a SNMP agent of the communication device. The communication device further comprises a transmitting unit configured to transmit, to the SNMP manager, a notification for an OID in the set of OIDs. The communication device further comprises a monitoring unit configured to monitor for an acknowledgement to the notification from the SNMP manager.

In an embodiment, the communication device may further comprise a transmitting unit configured to transmit, to the SNMP manager, an indication for allowing acknowledgements to notifications for the plurality of OIDs.

In an embodiment, the communication device may further comprise a transmitting unit configured to transmit, to the SNMP manager, a notification indicating a target event associated with an OID of the plurality of OIDs from a source; a monitoring unit configured to monitor for a report of a duplicated event associated with the OID of the plurality of OIDs from the source within a time period; and an ignoring unit configured to in response to receiving the report of the duplicated event within the time period, ignore the duplicated event.

In an embodiment, the communication device may further comprise a receiving unit configured to receive, from a source, a report of a target event associated with an OID of the plurality of OIDs; a monitoring unit configured to monitor for a report of a reverse event associated with the OID of the plurality of OIDs from the source within a time period; and an ignoring unit configured to in response to receiving the report of the reverse event within the time period, ignore the target event and the reverse event, and/or a transmitting module configured to in response to receiving the report of the reverse event within the time period, transmit, to the SNMP manager, a notification indicating a pair of the target event and the reverse event associated with the OID of the plurality of OIDs from the source.

In an embodiment, the communication device may further comprise a transmitting module configured to in response to no report of the reverse event within the time period, transmit, to the SNMP manager, a notification indicating the target event associated with the OID of the plurality of OIDs from the source.

In an embodiment, the time period may be determined based on a timer used to monitor for a duplicated event and/or a pair of a target event and a reverse event. The communication device may further comprise a receiving unit configured to receive, from the SNMP manager, a configuration for the timer.

In a fourth aspect of the present disclosure, there is provided a communication device. The communication device comprises a selecting unit configured to select a set of OIDs from a plurality of OIDs associated with a SNMP agent. The communication device further comprises a transmitting unit configured to transmit, to the SNMP agent, a configuration for enabling acknowledgements to notifications for the set of OID.

In an embodiment, the communication device may further comprise a receiving unit configured to receive, from the SNMP agent, an indication for allowing acknowledgements to notifications for the plurality of OIDs.

In an embodiment, the communication device may further comprise a transmitting unit configured to transmit, to the SNMP agent, a configuration for a timer used to monitor for a duplicated event and/or a pair of a target event and a reverse event.

In an embodiment, the communication device may further comprise a receiving unit configured to receive, from the SNMP agent, a notification indicating a pair of a target event and a reverse event associated with an OID of the plurality of OIDs from a source.

In a fifth aspect of the present disclosure, there is provided a communication device. The communication device comprises a processor and a memory coupled to the processor, the memory containing instructions executable by the processor, whereby the communication device is operative to perform the method according to the first or second aspect.

In a sixth aspect of the present disclosure, there is provided an apparatus. The apparatus comprises means for performing the method according to the first or second aspect.

In a seventh aspect of the disclosure, there is provided a computer-readable storage medium having instructions stored thereon, the instructions, which, when executed by at least one processor of a device, cause the device to perform the method according to the first or second aspect.

With the present disclosure, some notifications about fault events or other events may be sent from a SNMP agent to a SNMP manager with an ACK mechanism while some other notifications may be sent with no ACK mechanism. In this way, transmission reliability of the notifications and the efficiency of system resource utilization may be balanced.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is a diagram showing an example communication environment 100 in which embodiments of the present disclosure can be implemented.

FIG. 2 is a signaling diagram of a communication process between a SNMP agent and a SNMP manager in accordance with some embodiments of the present disclosure.

FIG. 3 is a signaling diagram of a communication process between the SNMP agent and the SNMP manager in accordance with some other embodiments of the present disclosure.

FIG. 4 is a diagram showing a flowchart of an example process of identifying a duplicated event in accordance with some embodiments of the present disclosure.

FIG. 5 is a diagram showing a flowchart of an example process of identifying a pair of flapped events in accordance with some embodiments of the present disclosure.

FIG. 6 is a diagram showing a flowchart of an example process of monitoring event frequency in accordance with some embodiments of the present disclosure.

FIG. 7 is a diagram showing a flowchart of an example communication method in accordance with some embodiments of the present disclosure.

FIG. 8 is a diagram showing a flowchart of an example communication method in accordance with some other embodiments of the present disclosure.

FIG. 9 is a block diagram showing a communication device in accordance with some embodiments.

FIG. 10 is a block diagram showing a communication device in accordance with some other embodiments.

FIG. 11 is a block diagram showing a communication device in accordance with yet other embodiments.

FIG. 12 is a block diagram showing a computer readable storage medium in accordance with some embodiments.

FIG. 13 is a block diagram showing an example of a communication system in accordance with some embodiments.

FIG. 14 is a block diagram showing a host in accordance with some embodiments.

FIG. 15 is a block diagram showing a virtualization environment in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The SNMP is a UDP protocol and, unlike a Transmission Control Protocol (TCP), may not guarantee no packet loss. A TRAP message (or an SNMP trap or a trap) may be sent from one application, which may act as a SNMP agent on a local device such as a router, to another application, which may act as a SNMP manager on a remote host or host server. The host or host server may be under the ownership or control of a network operator or provider or a service provider. The TRAP message may be used to enable network observability. For example, using the TRAP message, the local device may notify the remote host of network faults or events without a request from the host when faults or events occur. As such, the host may obtain the network observations in time.

As mentioned above, there is no ACK mechanism for the TRAP message. Thus, the local device may not know whether the remote host has received this message. As the SNMP is an UDP protocol, the TRAP message may be possibly lost for some reasons such as Address Resolution Protocol (ARP) changes on a forwarding path, network congestion, an outage of an intermediate device, a link flag, and/or the like. However, the loss of some types of traps may be unacceptable. By taking a “cold restart” trap as an example, the host may block the processing of any received trap until the “cold restart” trap is received, and thus the loss of a “cold restart” trap may cause a waste of memory resources and transmission resources.

An INFORM message (or a SNMP inform or an inform) may require an acknowledgement from a receiver. For example, after the SNMP manager receives the INFORM message, it may send an acknowledgement or confirmation message back to the SNMP agent. The agent may send an INFORM message repeatedly until it receives an ACK message. However, the frequent transmissions of the INFORM messages may cause a waste of resources such as local memory resources and network transmission bandwidth resources.

For example, an INFORM message may be used to report a port state of a local device. In some cases, the port state of the device may keep flapping, for example, about dozens of times every second. Each port flap triggers the “port down” and “port up” messages. Thus, a large number of INFORM messages may need to be reported by the local device to the remote host, and each of these messages may need the remote host to send an ACK. However, these messages may be lost due to transmission pressure of the network. If the host does not receive a message, for example, due to inability to process them, the local device may resend this message. The loss of a message at any point may cause the message to be resent on the SNMP agent, which may cause a severe load of both the host and the transmission network.

Moreover, at the local device, if an ACK is not received for an INFROM message sent to the host, this message may be retained in a queue, for example, in a cache. The loss of previous messages may lead to new messages blocked in the queue and occupying a large amount of memory resources. A large number of subsequent INFROM messages may be accumulated in the cache queue over time, which may finally cause the system memory nearly exhausted and even affect other services. Therefore, there is a need for a tradeoff between transmission reliability and resource overhead of the TRAP and INFORM messages.

Certain aspects of the disclosure and their embodiments may provide solutions to these or other challenges. Some embodiments of the present disclosure propose a notification scheme where some notifications about fault events or other events may be sent from a SNMP agent to a SNMP manager with an ACK mechanism (referred to as an inform mode) while some other notifications may be sent with no ACK mechanism (referred to as a trap mode). For example, some important SNMP messages, such as a “cold restart” message, a “warm restart” message and a “time synchronization lost” message, may be not allowed to be lost and thus be transmitted with the ACK mechanism. Some messages, which may be insignificant for a network operator or administrator, such as “port up” and “port down” messages, may be transmitted without the ACK mechanism, thereby saving various resources such as memory resources, processing resources, computing resources, network resources and/or the like.

In this way, the SNMP agent may send notifications to the SNMP manager in both the trap and inform modes. Compared to using one mode, either a trap mode or an inform mode, transmission reliability of the notifications and the efficiency of system resource utilization may be balanced.

In addition, the proposed scheme may improve network observability which may be a designed target of a trap or inform message. Furthermore, since SNMP is widely used in a Software Defined Network (SDN) system, the proposed scheme may improve SDN ecosystem as well.

Some example implementations will be described below with reference to the accompanying drawings.

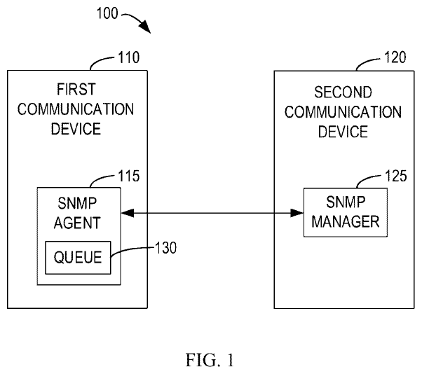

FIG. 1 illustrates an example communication environment 100 in which embodiments of the present disclosure can be implemented. In the communication environment 100, which may be a part of a communication system, a plurality of communication devices, including a first communication device 110 and a second communication device 120, can communicate with each other in a wireless or wired way. In an example, the communication system may be a SDN system. Communications in the communication environment 100 may be implemented according to any proper communication protocols and technologies.

Both the first and second communication devices 110 and 120 are capable of support SNMP. For example, as shown in FIG. 1, the first communication device 110 may comprise a SNMP agent 115, and the second communication device 120 may comprise a SNMP manager 125. The SNMP agent 115 and the SNMP manager 125 may be programs or processes running on the first and second communication devices 110 and 120, respectively. The first and second communications 110 and 120 may communicate SNMP messages via the SNMP agent 115 and the SNMP manager 125.

The first and second communication devices 110 and 120 may be any devices that can communication based on SNMP. In some embodiments, the first communication device 110 may be a router or a switch, and the second device 120 may be a host server. In some embodiments, the first and second communication devices 110 and 120 may be deployed in a core network of a cellular communication network. In an example, the first communication device 110 may operate as a router that may communicate with baseband units of base stations to obtain failure events in a radio access network. In another example, the first communication device 110 may operate as a switch connected to a baseband unit. The second communication device 120 may operate as a host server to receive a report of the failure events from the first communication device 110.

It is to be understood that the numbers of devices are illustrated in FIG. 1 only for the purpose of illustration without suggesting any limitations. The communication environment 100 may include any suitable numbers of devices for implementing embodiments of the present disclosure. In an example, there may be a plurality of devices arranged with SNMP agents which may all report network failure events to the SNMP manager 115 of the second device 120.

It is also to be understood that the devices as illustrated in FIG. 1 are only examples. Other devices such as monitored or managed devices in the downstream of the first communication device 110 may be also included in the environment 100.

In some embodiments, the SNMP agent 115 may maintain various state data of the first communication device 110 or downstream devices to be monitored. The SNMP agent 115 may transmit a notification to the SNMP manager 125 if fault events or other events occur at the first communication device 110 or reported by other devices (not shown). The notifications to be transmitted may be kept in a queue 130. In various embodiments, both the inform mode and the trap mode may be enabled for the SNMP agent 115, so as to improve resource utilization and system efficiency.

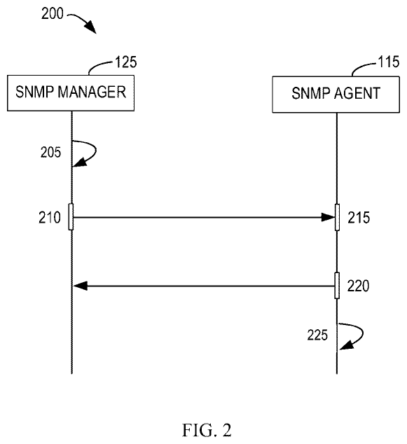

FIG. 2 shows a signaling diagram of a communication process 200 between the SNMP agent 115 of the first communication device 110 and the SNMP manager 125 of the second communication device 120 in accordance with some embodiments of the present disclosure.

As shown in FIG. 2, the SNMP manager 125 may select (205) a set of OIDs from a plurality of OIDs associated with the SNMP agent 115. An OID may identify a managed object (or a managed event) such as a port state, a start mode, a temperature, a voltage, and/or the like. In an example, the SNMP manager 125 may select some OIDs for critical or important objects (or events) and configure the notifications of these OIDs to be acknowledged. For other OIDs that are not selected, no acknowledgement may be required. In this way, the SNMP agent 115 may support both the inform-mode and trap-mode notifications.

The SNMP manager 125 may transmit (210), to the SNMP agent 115, a configuration for acknowledgements to notifications for the set of OIDs. Accordingly, the SNMP agent 115 may receive (215) this configuration from the SNMP manager 125. The configuration may be communicated in any suitable way. In an example, the configuration may be communicated via management information base (MIB).

The MIB may be a file and may maintain a series of attributes of the managed objects such as a name of an object, a state of an object, a data type of an object, and/or the like. The MIB may also maintain various configurations for the managed objects. In the context of the present disclosure, MIB may also be referred to as a MIB file. The SNMP manager 125 may query, set, modify, and/or extend data maintained in MIB. In some embodiments, the SNMP manager 125 may modify the MIB associated with the SNMP agent 115 to set or modify a configuration of some notifications to enable the acknowledgement mechanism. The MIB may be created by the SNMP agent 115 to identify OIDs of the managed objects.

After the MIB is modified, the SNMP manager 125 may send it back to the SNMP agent 115 to indicate the configuration for enabling the acknowledgements to some notifications. As such, the SNMP manager 125 may control the SNMP agent 115 through this MIB to use the inform-mode notifications for some OIDs. The trap-mode notifications may still be used for other OIDs.

In some embodiments, before the SNMP manager 125 transmits a configuration for enabling the acknowledgements to the notifications, the SNMP agent 115 may transmit an indication to the SNMP manager 125 that acknowledgements to notifications are allowed for the plurality of OIDs. In an example, this indication may be included in the MIB file created by the SNMP agent 115. In this example, after the SNMP manager 125 gets (for example, polls) the MIB file from the SNMP agent 115, the SNMP manager 125 may obtain the indication for allowing acknowledgements to notifications for the plurality of OIDs. In this way, the inform-mode notifications may be enabled in a more flexible and efficient way.

After the configuration is communicated from the SNMP manager 125 to the SNMP agent 115, the SNMP agent 115 may transmit (220), to the SNMP manager 125, a notification for an OID in the set of OIDs, for example, to indicate occurrence of an event. For example, after the SNMP agent 115 receives, from a source, a report of an event associated with an OID in the set of OIDs, the SNMP agent 115 may transmit a notification of the event to the SNMP manager 125. The source may be a device, a component, a unit or an application that is managed or monitored by the network.

In an example, after the report of the event associated with an OID is received, the SNMP agent 115 may determine whether an inform mode or a trap mode may be used to notify this event to the SNMP manager 125. For example, in the embodiments where MIB is used to transmit the configuration for enabling acknowledgements to notifications for some OIDs, the SNMP agent 115 may search the MIB for the OID. If the OID is found, the SNMP agent 115 may determine that an inform mode is to be used.

Then, the SNMP agent 115 may monitor (225) for an acknowledgement from the SNMP manager 125. In the process 200, the SNMP manager 125 may or may not receive the notification sent by the SNMP agent 115. If the notification is received, the SNMP manager 125 may transmit an acknowledgement to the notification.

In an example, the notification mode used for OIDs may be configured by a network operator or provider. In this way, the acknowledgement mechanism may be flexibly configured for some OIDs or events, for example, depending on requirements or needs of a network operator.

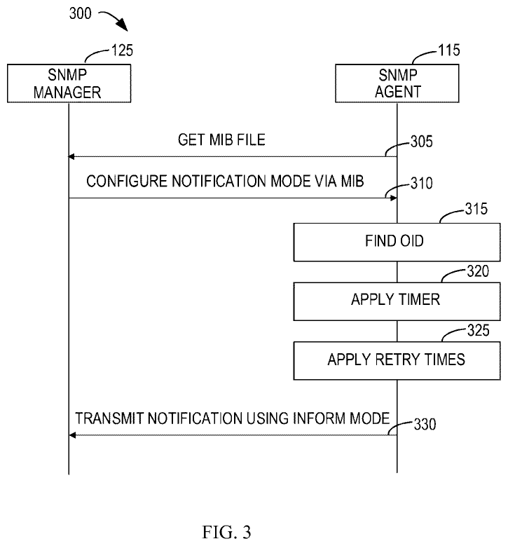

FIG. 3 shows a signaling diagram of a communication process 300 between the SNMP agent 115 and the SNMP manager 125 in accordance with some other embodiments of the present disclosure. In this example, the configuration for enabling the acknowledgements to the notifications may be communicated via MIB.

As shown in FIG. 3, at 305, the SNMP manager 125 may get a MIB file from the SNMP agent 115. This MIB file may be created by the SNMP agent 115 and used to indicate that notifications for a plurality of OIDs are allowed to be acknowledged. At 310, the SNMP manager 125 may configure a notification mode for OIDs via MIB. For example, the SNMP manager 125 may select a set of OIDs and configure an inform mode for these OIDs.

If a report of an event associated with an OID is received, the SNMP agent 115 may search the MIB file for the OID to check whether this OID is specified by the SNMP manager 125. In the process 300, as shown in FIG. 3, the agent 115 may find the OID at 315. This may mean that this OID is configured by the SNMP manager 125 to use an inform mode.

In some embodiments, a timer (also referred to as a monitoring timer herein) and/or retry times may be used to monitor for an acknowledgement to the notification from the SNMP manager 125. Such a timer and retry times may also be configured in the MIB file. In this example, as shown in FIG. 3, the SNMP agent 115 may apply a timer at 320 and apply retry times at 325. Then, at 330, the SNMP agent 115 may transmit a notification to the SNMP manager 125 using the inform mode.

In some embodiments, a monitoring mechanism for a frequency of event reports from sources may be provided on the SNMP agent 115. If some events are too frequent, it may be too meaningless to report them to the SNMP manager 125, and thus these events may be ignored. For example, if a state of a port is flapped dozens of times per second, event reports about such flapping may not be required by the SNMP manager 125 and thus may be invalid. Moreover, these reports may cause impacts on the transmission network as well as the SNMP manager 125. With this monitoring mechanism, the SNMP agent 115 may monitor event validity and identify and filter out invalid events such as too frequent changes of a port state.

Such a monitoring mechanism may be applied in both an inform mode and a trap mode. Thus, a local trap monitoring mechanism may be provided at the SNMP agent 115 to filter out improper events and prevent notifications of the invalid events from causing impacts on the network and system.

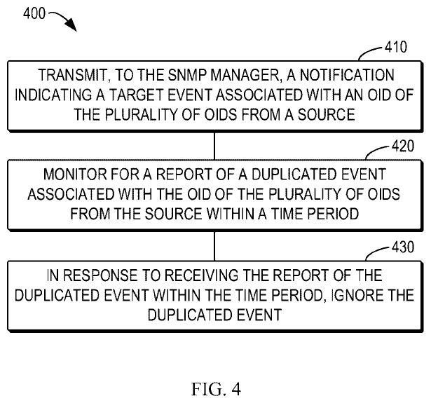

Some embodiments in this respect will be discussed below with reference to FIGS. 4 to 6.

FIG. 4 shows a flowchart of an example process 400 of identifying a duplicated event in accordance with some embodiments of the present disclosure. The method 400 may be implemented by the SNMP agent 115. For the purpose of discussion, the method 400 will be described from the perspective of the SNMP agent 115 with reference to FIG. 1.

As shown in FIG. 4, at block 410, the SNMP agent 115 may transmit, to the SNMP manager 125, a notification indicating a target event associated with an OID of the plurality of OIDs from a source. At block 420, the SNMP agent 115 may monitor for a report of a duplicated event associated with the OID of the plurality of OIDs from the source within a time period.

In some embodiments, the time period may be determined based on a timer, also referred to as a soak timer herein. The soak timer may be set on the SNMP agent 115 and used to monitor the OID of the same source. In some embodiments, the SNMP agent 115 may receive a configuration for a soak time or a soak timer from the SNMP manager 125. The configuration for the soak time may be also communicated via MIB.

Example data of a MIB file is illustrated as below.

```
CRITICAL-ACK-MIB DEFINITIONS ::= BEGIN
IMPORTS
  MODULE-IDENTITY,
  OBJECT-TYPE,
  Unsigned32
    FROM SNMPv2-SMI
  OBJECT-GROUP,
  SnmpAdminString
    FROM SNMP-FRAMEWORK-MIB
  eriRouterMgmt
    FROM ROUTER-SMI;
CriticalAckMIB MODULE-IDENTITY
  LAST-UPDATED
  ORGANIZATION
  CONTACT-INFO
  DESCRIPTION
    “The MIB used to manage the important nodes,
    that is, the information
    that the agent expects the server to receive. After
    receiving the trap from these nodes, the server will
    reply with a confirmation message.”
  REVISION
  DESCRIPTION
    “Initial version.”
  ::= { eriRouterMgmt 777 }
CriticalAckMIBObjects OBJECT IDENTIFIER
  ::= { CriticalAckMIB 1 }
-- MIB Objects
```

| | |
|---|---|
| CriticalAckTable | OBJECT-TYPE |
| SYNTAX | SEQUENCE OF CriticalAckEntry |
| MAX-ACCESS | not-accessible |
| STATUS | current |

```
  DESCRIPTION
    “This table contains the critical mib nodes.”
  ::= { CriticalAckMIBObjects 1 }
```

| | |
|---|---|
| CriticalAckEntry | OBJECT-TYPE |
| SYNTAX | CriticalAckActiveEntry |
| MAX-ACCESS | not-accessible |
| STATUS | current |

```
  DESCRIPTION
    “Entries appear in this table when critical
    mib nodes are set.”
  INDEX { criticalAckIndex }
  ::= { CriticalAckMIBObjects 1 }
CriticalAckActiveEntry ::= SEQUENCE {
```

| | |
|---|---|
| criticalAckIndex | SnmpAdminString, |
| criticalAckRetryTimes | Unsigned32, |
| criticalAckTimeout | Unsigned32, |
| criticalAckSoakTime | Unsigned32 |

}

| | |
|---|---|
| criticalAckIndex | OBJECT-TYPE |

SYNTAX SnmpAdminString {1.32}

| | |
|---|---|
| MAX-ACCESS | read-create |
| STATUS | current |

```
  DESCRIPTION
  “Specifies a trap OID for agent to take specific action.”
  ::= { CriticalAckMIBObjects 1 }
```

| | |
|---|---|
| criticalAckRetryTimes | OBJECT-TYPE |

SYNTAX Unsigned32 {2..10}

| | |
|---|---|
| MAX-ACCESS | read-create |
| STATUS | current |

```
  DESCRIPTION
  “Specifies the retry times after agent sends a critical trap.”
  ::= { CriticalAckMIBObjects 2 }
```

| | |
|---|---|
| criticalAckTimeout | OBJECT-TYPE |

SYNTAX Unsigned32 {4..28}

| | |
|---|---|
| MAX-ACCESS | read-create |
| STATUS | current |

```
  DESCRIPTION
  “Specifies the timeout period (in seconds) after agent
  sends a critical trap”
  DEFVAL { 14 }
  ::= { CriticalAckMIBObjects 3 }
```

| | |
|---|---|
| criticalAckSoakTime | OBJECT-TYPE |

SYNTAX Unsigned32

| | |
|---|---|
| MAX-ACCESS | read-create |
| STATUS | current |

```
  DESCRIPTION
  “Specifies the soak time in million second for a trap from same source,
  too frequent trap from a same source will be ignore.”
  DEFVAL { 500 }
  ::= { CriticalAckMIBObjects 4 }
```

As illustrated, in this example, the monitoring mechanism of the event frequency may be applied to the inform-mode notifications. The MIB file may maintain the configuration for enabling the acknowledgements to the notifications (“criticalAckIndex”) and the related configuration of a monitoring timer and retry times (“criticalAckTimeout” and “criticalAckRetryTimes”), and the configuration for the soak time (“criticalAckSoakTime”). The value of the monitoring timer and the soak timer may be set to any suitable value depending on the network deployment and the specific implementations.

At block 430, in response to receiving the report of the duplicated event within the time period, the SNMP agent 115 may ignore the duplicated event. In an example, if the same event for the OID of the same source is reported until expiration of the soak timer, which, for example, may be set to 2 seconds, then the SNMP agent 115 may ignore this event and may not report it to the SNMP manager 125. For example, if the SNMP agent 115 has reported the notification of the “port down” (for example, “port 7 down”) event to the SNMP manager 125 in last 2 seconds, then the SNMP agent 115 may ignore the “port down” event and may not report the notification of the “port down” event to the SNMP manager 125 again when the “port down” event reaches the SNMP agent 115 again within 2 seconds.

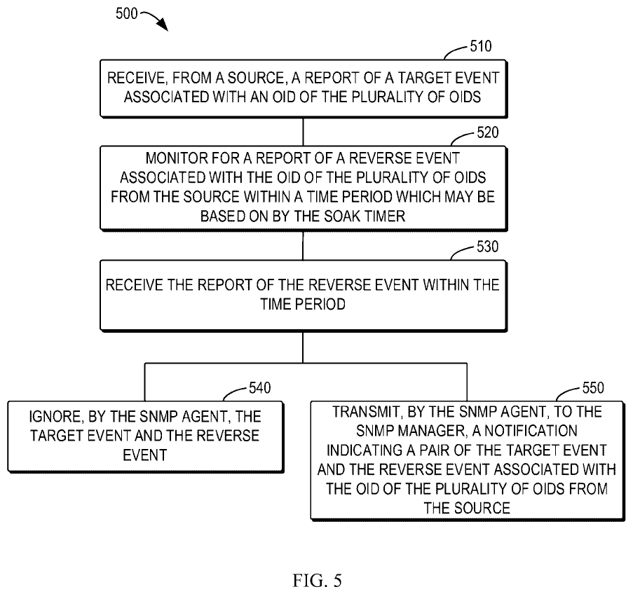

In some embodiments, the soak timer may also be used to monitor for a pair of a target event and a reverse event (also referred to as a pair of flapped events). Some embodiments in this regard will be discussed below the reference to FIG. 5.

FIG. 5 shows a flowchart of an example process 500 of identifying a pair of flapped events in accordance with some embodiments of the present disclosure. The method 500 may be implemented by the SNMP agent 115. For the purpose of discussion, the method 500 will be described from the perspective of the SNMP agent 115 with reference to FIG. 1.

As shown in FIG. 5, at block 510, the SNMP agent 115 may receive, from a source, a report of a target event associated with an OID of the plurality of OIDs. At block 520, the SNMP agent 115 may monitor for a report of a reverse event associated with the OID of the plurality of OIDs from the source within a time period which may be based on by the soak timer. At block 530, the SNMP agent 115 may receive the report of the reverse event within the time period. At block 540, the SNMP agent 115 may ignore the target event and the reverse event. In some embodiments, in response to no report of the reverse event within the time period, the SNMP agent 115 may transmit, to the SNMP manager 125, a notification indicating the target event associated with the OID of the plurality of OIDs from the source.

In an example, if the SNMP agent 115 receives an event such as a “port down” event from a port (for example, port 7), the SNMP agent 115 may not report it to the SNMP manager 125 immediately, but soak it for two seconds. If an opposite event from the same source (for example, a “port up” event from port 7) reaches the SNMP agent 115 until expiration of the soak timer (for example, within two seconds), the SNMP agent 115 may cancel the soaking and ignore the reporting of the events. In this case, neither “port down” nor “port up” event of port 7 may be reported. If no reverse event (for example, no “port up” event from port 7) reaches the SNMP agent 115 within the two seconds, the SNMP agent 115 may send the notification of the “port down” event to the SNMP manager 125.

Alternatively, or in addition, at block 550, the SNMP agent 115 may transmit a notification to the SNMP manager 125 to indicate a pair of the target event and the reverse event. In an example, if there are the frequent flapped events, such as “port up” and “port down” events, the SNMP agent 115 may report this pair of flapped events. In this way, the SNMP manager 125 (or the network operator) may be aware of the flapped events, and the network observability may be further improved. The pair of flapped events may be reported for fewer times or even once, to further reduce the system overhead.

FIG. 6 shows a flowchart of an example process 600 of monitoring event frequency in accordance with some embodiments of the present disclosure. The process 600 involves the operations of the SNMP manager 125, the SNMP agent 115 and a source. In this example, the SNMP manager 125 may comprise a configuration module 602 and an event receiver 604. The configuration module 602 may be operative to configure a reporting scheme of the SNMP agent 115, and the event receiver 606 may be operative to receive notifications reported by the SNMP agent 115.

As shown in FIG. 6, at 606, the SNMP manager 125 may configure a soak time for the SNMP agent 115 via MIB. At 608, an application 610 as a monitored object may report an event to the SNMP agent 115. At 612, the SNMP agent 115 may start a soak timer. At 614, the SNMP agent 115 may determine whether a duplicated event occurs. If yes, the SNMP agent 115 may ignore the duplicated event at 616. If no, then at 618, the SNMP agent 115 may determine whether an opposite of the monitored event occurs. If yes, the SNMP agent 115 may ignore both the monitored event and the opposite event at 620. If no, then at 622, the SNMP agent 115 may report this pair of flapped events one time if the flapping is frequent. At 624, in response to soak timeout, the SNMP agent 115 may send a notification to the event receiver 604.

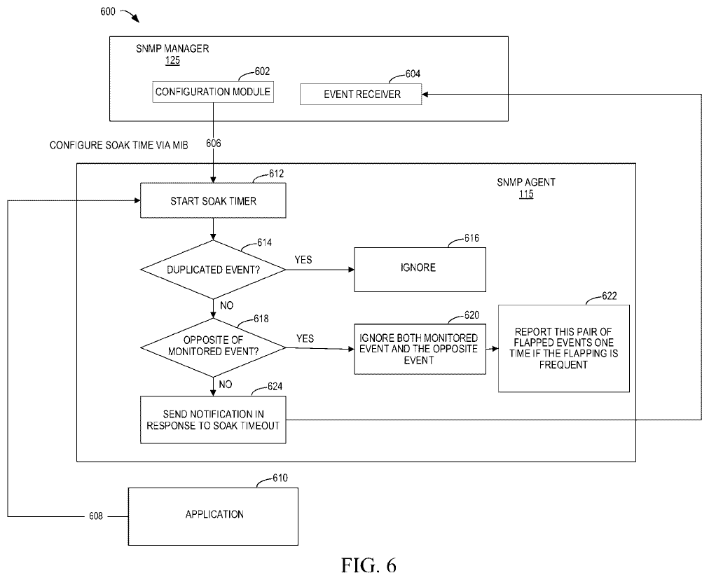

FIG. 7 shows a flowchart of an example communication method 700 in accordance with some example embodiments of the present disclosure. The method 700 may be implemented by the first communication device 110 as shown in FIG. 1. For the purpose of discussion, the method 700 will be described from the perspective of the first communication device 110 with reference to FIG. 1.

As shown in FIG. 7, at block 710, the first communication device 110 receives, by the SNMP agent 115, from the SNMP manager 125, a configuration for enabling acknowledgements to notifications for a set of OIDs. The set of OIDs is selected from a plurality of OIDs associated with the SNMP agent. At block 720, the first communication device 110 transmits, by the SNMP agent 115, to the SNMP manager 125, a notification for an OID in the set of OIDs. At block 730, the first communication device 110 monitors, by the SNMP agent 115, for an acknowledgement to the notification from the SNMP manager 125.

In some embodiments, the first communication device 110 may transmit, by the SNMP agent 115, to the SNMP manager 125, an indication for allowing acknowledgements to notifications for the plurality of OIDs.

In some embodiments, the first communication device 110 may transmit, by the SNMP agent 115, to the SNMP manager 125, a notification indicating a target event associated with an OID of the plurality of OIDs from a source. Then, the first communication device 110 may monitor, by the SNMP agent 115, for a report of a duplicated event associated with the OID of the plurality of OIDs from the source within a time period. If the report of the duplicated event is received within the time period, the first communication device 110 may ignore the duplicated event.

In some embodiments, the first communication device 110 may receive, by the SNMP agent 115, from a source, a report of a target event associated with an OID of the plurality of OIDs. Then, the first communication device 110 may monitor, by the SNMP agent, for a report of a reverse event associated with the OID of the plurality of OIDs from the source within a time period. If the report of the reverse event is received within the time period, the first communication device 110 may ignore, by the SNMP agent 115, the target event and the reverse event. Alternatively, or in addition, the first communication device 110 may transmit, by the SNMP agent 115, to the SNMP manager 125, a notification indicating a pair of the target event and the reverse event associated with the OID of the plurality of OIDs from the source.

In some embodiments, if there is no report of the reverse event within the time period, the first communication device 110 may transmit, by the SNMP agent 115, to the SNMP manager 125, a notification indicating the target event associated with the OID of the plurality of OIDs from the source.

In some embodiments, the time period may be determined based on a timer used to monitor for a duplicated event and/or a pair of a target event and a reverse event. The first communication device 110 may receive, by the SNMP agent 115, from the SNMP manager 125, a configuration for the timer.

In some embodiments, the configuration for enabling the acknowledgements to the notifications for the set of OIDs, the indication for allowing the acknowledgements to the notifications for the plurality of OIDs, and/or the configuration for the timer may be communicated via MIB.

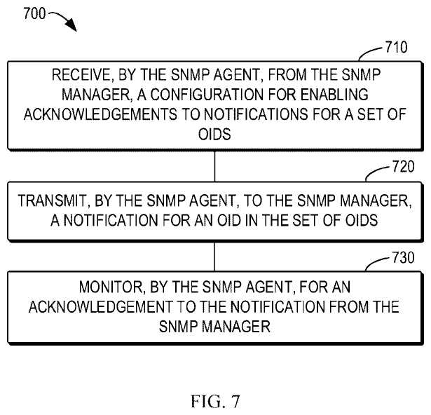

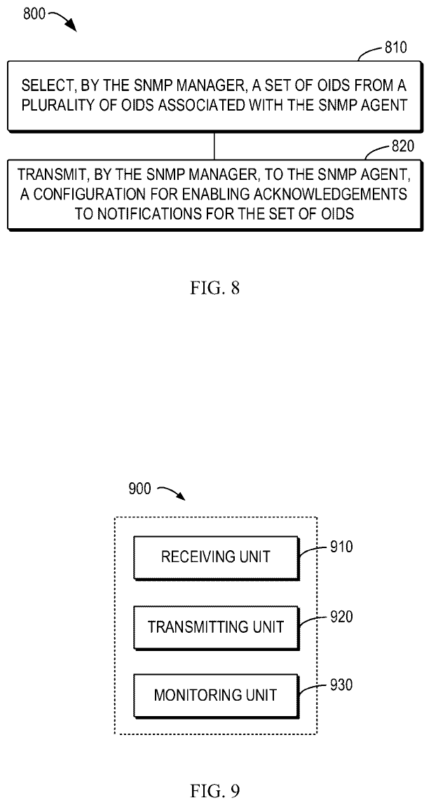

FIG. 8 shows a flowchart of an example communication method 800 in accordance with some example embodiments of the present disclosure. The method 800 may be implemented by the second communication device 120 as shown in FIG. 1. For the purpose of discussion, the method 800 will be described from the perspective of the second communication device 120 with reference to FIG. 1.

As shown in FIG. 8, at block 810, the second communication device 120 selects, by the SNMP manager 125, a set of OIDs from a plurality of OIDs associated with the SNMP agent 115. At block 820, the second communication device 120 transmits, by the SNMP manager 125, to the SNMP agent 115, a configuration for enabling acknowledgements to notifications for the set of OIDs.

In some embodiments, the second communication device 120 may receive, by the SNMP manager 125, from the SNMP agent 115, an indication for allowing acknowledgements to notifications for the plurality of OIDs.

In some embodiments, the second communication device 120 may transmit, by the SNMP manager 125, to the SNMP agent 115, a configuration for a timer used to monitor for a duplicated event and/or a pair of a target event and a reverse event.

In some embodiments, the configuration for enabling the acknowledgements to the notifications for the set of OIDs, the indication for allowing the acknowledgements to the notifications for the plurality of OIDs, and/or the configuration for the timer may be communicated via MIB.

In some embodiments, the second communication device 120 may receive, by the SNMP manager 125, from the SNMP agent 115, a notification indicating a pair of a target event and a reverse event associated with an OID of the plurality of OIDs from a source.

All operations and features related to the first communication device 110 (or the SNMP agent 115) and the second communication device 120 (or the SNMP manager 125) as described above with reference to FIGS. 1 to 6 are likewise applicable to the methods 700 and 800 and have similar effects. For the purpose of simplification, the details will be omitted.

FIG. 9 shows function units of a communication device 900 in accordance with some embodiments. The communication device 900 may be an example implementation of the first communication device 110 as shown in FIG. 1.

As shown in FIG. 9, the communication device 900 comprises a receiving unit 910 configure to receive, from the SNMP manager 125, a configuration for enabling acknowledgements to notifications for a set of OIDs, the set of OIDs being selected from a plurality of OIDs associated with the SNMP agent 115 of the communication device; a transmitting unit 920 configured to transmit, to the SNMP manager 125, a notification for an OID in the set of OIDs; and a monitoring unit 930 configured to monitor for an acknowledgement to the notification from the SNMP manager 125.

In some embodiments, the communication device 900 may further comprise: a transmitting unit configured to transmit, to the SNMP manager 125, an indication for allowing acknowledgements to notifications for the plurality of OIDs.

In some embodiments, the communication device 900 may further comprise: a transmitting unit configured to transmit, to the SNMP manager 125, a notification indicating a target event associated with an OID of the plurality of OIDs from a source; a monitoring unit configured to monitor for a report of a duplicated event associated with the OID of the plurality of OIDs from the source within a time period; and an ignoring unit configured to in response to receiving the report of the duplicated event within the time period, ignore the duplicated event.

In some embodiments, the communication device 900 may further comprise: a receiving unit configured to receive, from a source, a report of a target event associated with an OID of the plurality of OIDs; a monitoring unit configured to monitor for a report of a reverse event associated with the OID of the plurality of OIDs from the source within a time period; and an ignoring unit configured to in response to receiving the report of the reverse event within the time period, ignore the target event and the reverse event, and/or a transmitting module configured to in response to receiving the report of the reverse event within the time period, transmit, to the SNMP manager 125, a notification indicating a pair of the target event and the reverse event associated with the OID of the plurality of OIDs from the source.

In some embodiments, the communication device 900 may further comprise: a transmitting module configured to in response to no report of the reverse event within the time period, transmit, to the SNMP manager 125, a notification indicating the target event associated with the OID of the plurality of OIDs from the source.

In some embodiments, the time period may be determined based on a timer used to monitor for a duplicated event and/or a pair of a target event and a reverse event. The communication device 900 may further comprise: a receiving unit configured to receive, from the SNMP manager 125, a configuration for the timer.

In some embodiments, the configuration for enabling the acknowledgements to the notifications for the set of OIDs, the indication for allowing the acknowledgements to the notifications for the plurality of OIDs, and/or the configuration for the timer may be communicated via MIB.

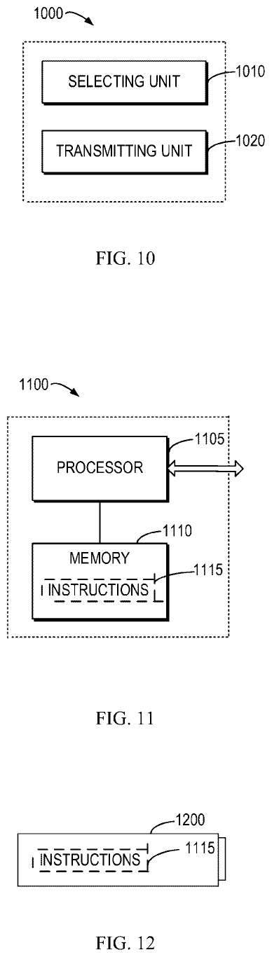

FIG. 10 shows function units of a communication device 1000 in accordance with some other embodiments. The communication device 1000 may be an example implementation of the second communication device 120 as shown in FIG. 1.

As shown in FIG. 10, the communication device 1000 comprises a selecting unit 1010 configured to select a set of OIDs from a plurality of OIDs associated with the SNMP agent 115; and a transmitting unit 1020 configured to transmit, to the SNMP agent 115, a configuration for enabling acknowledgements to notifications for the set of OIDs.

In some embodiments, the communication device 1000 may further comprise: a receiving unit configured to receive, from the SNMP agent 115, an indication for allowing acknowledgements to notifications for the plurality of OIDs.

In some embodiments, the communication device 1000 may further comprise: a transmitting unit configured to transmit, to the SNMP agent 115, a configuration for a timer used to monitor for a duplicated event and/or a pair of a target event and a reverse event.

In some embodiments, the configuration for enabling the acknowledgements to the notifications for the set of OID, the indication for allowing the acknowledgements to the notifications for the plurality of OIDs, and/or the configuration for the timer is communicated via MIB.

In some embodiments, the communication device 1000 may further comprise: a receiving unit configured to receive, from the SNMP agent, a notification indicating a pair of a target event and a reverse event associated with an OID of the plurality of OIDs from a source.

All operations and features related to the first communication device 110 (or the SNMP agent 115) and the second communication device 120 (or the SNMP manager 125) as described above with reference to FIGS. 1 to 6 are likewise applicable to the communication devices 900 and 1000 and have similar effects. For the purpose of simplification, the details will be omitted.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments, an apparatus capable of performing the method 700 may comprise means for performing the respective operations of the method 700. The means may be implemented in any suitable form. For example, the means may be implemented in a circuitry or software module. The apparatus may comprise means for receiving, by a SNMP agent, from a SNMP manager, a configuration for enabling acknowledgements to notifications for a set of OIDs, the set of OIDs being selected from a plurality of OIDs associated with the SNMP agent; means for transmitting, by the SNMP agent, to the SNMP manager, a notification for an OID in the set of OIDs; and means for monitoring, by the SNMP agent, for an acknowledgement to the notification from the SNMP manager.

In an embodiment, the apparatus may further comprise means for implementing actions or operations related to the first communication device 110 (or the SNMP agent 115) according to any of the above-mentioned embodiments described with reference to FIGS. 1 to 6.

In some embodiments, an apparatus capable of performing the method 800 may comprise means for performing the respective operations of the method 800. The means may be implemented in any suitable form. For example, the means may be implemented in a circuitry or software module. The apparatus may comprise means for selecting, by a SNMP manager, a set of OIDs from a plurality of OIDs associated with a SNMP agent; and means for transmitting, by the SNMP manager, to the SNMP agent, a configuration for enabling acknowledgements to notifications for the set of OIDs.

In an embodiment, the apparatus may further comprise means for implementing actions or operations related to the second communication device 120 (or the SNMP manager 125) according to any of the above-mentioned embodiments described with reference to FIGS. 1 to 6.

FIG. 11 shows a communication device 1100 in accordance with yest other embodiments. The communication device 1100 may operate as either the first communication device 110 or the second communication device 120 as shown in FIG. 1.

As shown in FIG. 11, the communication device 1100 may comprise a processor 1105 and a memory 1110. The memory 1110 may contain instructions 1115 executable by the processor 1105, whereby the communication device 1100 may be operative to implement actions or operations related to the first communication device 110 (or the SNMP agent 115) or the second communication device 120 (or the SNMP manager 125) according to any of the above-mentioned embodiments described with reference to FIGS. 1 to 6.

The processor 1105 may be any kind of processing component, such as one or more microprocessor or microcontrollers, as well as other digital hardware, which may include digital signal processors (DSPs), special-purpose digital logic, and the like. The memory 1110 may be any kind of storage component, such as read-only memory (ROM), random-access memory, cache memory, flash memory devices, optical storage devices, etc.

FIG. 12 shows a computer readable storage medium in accordance with some embodiments.

As shown in FIG. 12, the computer readable storage medium 1200 comprising instructions 1115 which when executed by a processor of a device, cause the device to perform any above-mentioned embodiments described with reference to FIGS. 1A to 5B.

The computer readable storage medium 1200 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

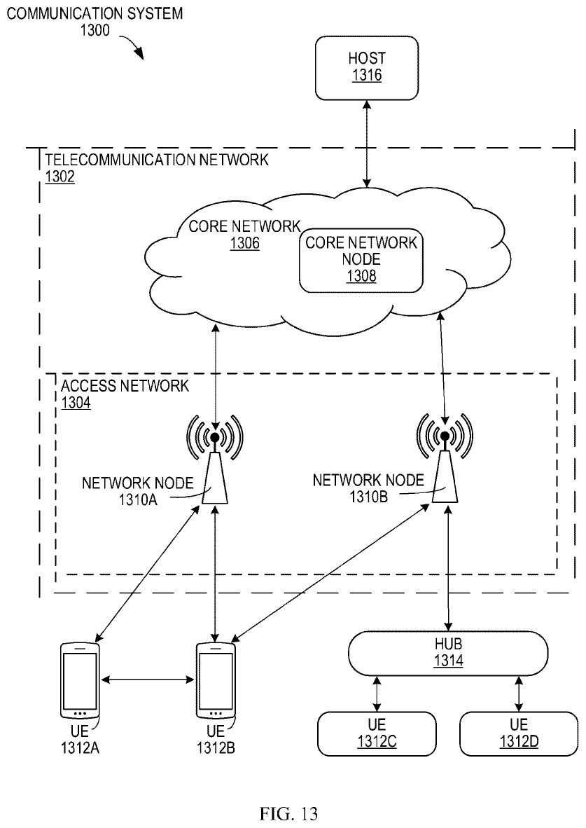

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310A and 1310B (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312A, 1312B, 1312C, and 1312D (one or more of which may be generally referred to as UEs 1312) to the core network 1306 over one or more wireless connections. In some embodiments, the first communication device 110 as shown in FIG. 1 may operate as a network node such as a router in the core network 1306.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server. In some embodiments, the second communication device 120 as shown in FIG. 1 may operate as the host 1316.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

As used herein, a network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

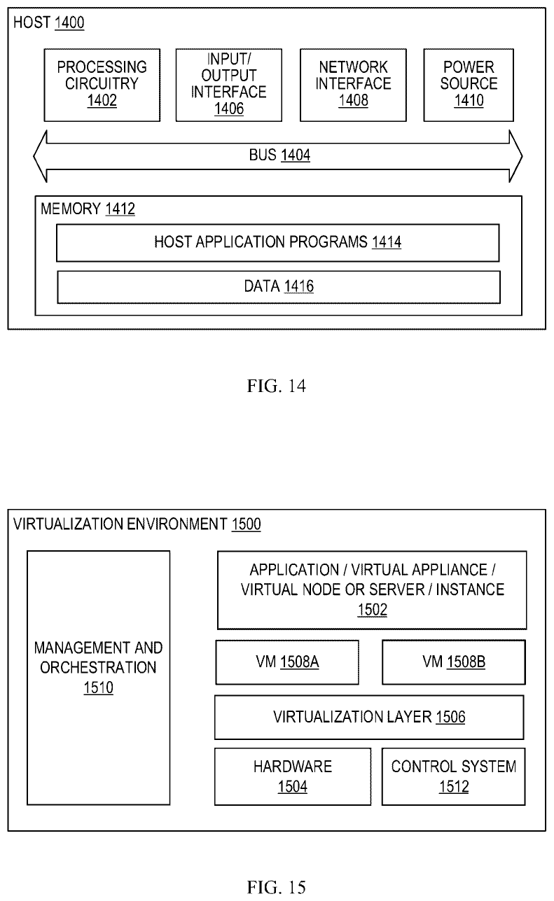

FIG. 14 is a block diagram of a host 1400, which may be an embodiment of the host 1316 of FIG. 13, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 10 and 11, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508A and 1508B (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Abbreviations

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| SNMP | A Simple Network Management Protocol |
| UDP | User Datagram Protocol |
| TCP | Transmission Control Protocol |
| ACK | Acknowledgement |
| PDU | Protocol Data Unit |
| MIB | Management Information Base |
| OID | Object Identifier |

Hereinafter, the solution will be further described as follows.

### Brief Summary of the Proposed Solution

1. Use inform mode for some traps, and use the original trap mode (without ACK) for others.
2. In inform mode, a trap frequency monitoring mechanism is provided on the SNMP agent. Traps that are too frequent are ignored, because it is meaningless to report them.

### Detailed Description of the Proposed Solution

### 1: Enable Inform Mode Trap and Original Mode Trap for an Agent at the Same Time:

At present, an obvious disadvantage of SNMP trap sending is that an agent can only use one sending mode. Either all traps of this agent use inform mode (requiring the sever to reply ACK) or use the original mode (it is impossible to know whether the trap is received by the sever).

Inform mode naturally introduces more system resource overhead (as described in the problem description section) and in some cases even introduces huge problems.

The Original mode cannot guarantee that the server receives a trap. For some very critical traps, there is no reliability guarantee.

So here provides a way to let agent enable inform mode trap and original mode trap at the same time.

The SNMP sever can control the agent through this MIB and set the agent to use inform mode trap (send trap requiring ACK) for some Object Identifier (OID). Other OID still use the original trap mode.

In this way, it changes the situation that an SNMP agent can only send inform mode traps or original traps. A SNMP agent can support inform mode trap and original mode trap at the same time.

### 2: Monitor Trap Validity on Agent, Prevent Invalid Trap Reporting:

Some traps are invalid, for example, the state of a port is flap dozens of times per second. These traps are not required by sever and can cause huge problems. Therefore, this paper provides a method to identify and filter such traps.

Soak mechanism:
1. Set a soak timer on the SNMP agent. Soak timer is used to monitor the OID of the same source. Here we have 2 seconds as an example.
2. If the OID of the same source reports the same event within two seconds, the agent ignores this trap and does not report it to the SNMP server. For example, if port 7 has already reported the trap of “port down” trap to SNMP sever in last 2 seconds, the SNMP agent ignores and does not report the trap to the SNMP sever if the trap of “port 7 down” reaches the SNMP agent within 2 seconds.
3. The Agent receives an event and doesn't report it immediately, soak for two seconds. If an opposite event from the same source reaches the agent within two seconds, cancel the soak and ignore the reporting of the event. If no reverse event reaches the agent within two seconds, the trap is reported. For example, if the SNMP agent receives “port down” from port 7, it does not send the trap to the SNMP server immediately but soak for two seconds. If the SNMP agent receives “port up” from port 7 within two seconds, then neither “port down” nor “port up” of port 7 is reported. If no “port up” from port 7 is received within two seconds, the “port down” trap of port 7 is sent to the SNMP sever.
4. If there is frequent flapped event, for example “port up” and “port down”, report this pair of flapped events once, this is to mean report “port up” trap and “port down” trap on time.

This is because this solution filter the flapped event that means some events really happened are ignored, however the operator may care about the flapped event so here report then one time to inform the operator.

### Advantages of the Proposed Solution

The SNMP agent can use both inform mode and original mode to send traps at the same time. Meanwhile, the SNMP agent monitors trap validity and filters invalid traps, such as port too frequent flap trap.

The current standard defines that an agent can send only one trap mode, either all traps are in inform mode or all traps are in the original trap mode. This cannot balance the reliability of trap and the efficiency of system resource utilization. This solution provides a way to have the best of both worlds.

At the same time, the solution provides a local trap monitoring mechanism to filter out improper traps and prevent these invalid traps from causing huge impact on the transmission network and SNMP server.

With this solution, the Network Observability could be improved as well as this solution could benefit to SDN ecosystem. Because the SNMP trap is used for Network Observability from day one designer, so this part improvement contributes to a better Network Observability naturally. Meanwhile, SNNP is widely integrated into SDN system, so this solution improves SND relevantly.

1. A communication method, comprising:
receiving, by a Simple Network Management Protocol, SNMP, agent, from a SNMP manager, a configuration for enabling acknowledgements to notifications for a set of object identifiers, OIDs, the set of OIDs being selected from a plurality of OIDs associated with the SNMP agent;
transmitting, by the SNMP agent, to the SNMP manager, a notification for an OID in the set of OIDs; and
monitoring, by the SNMP agent, for an acknowledgement to the notification from the SNMP manager.

2. The communication method of claim 1, further comprising:
transmitting, by the SNMP agent, to the SNMP manager, an indication for allowing acknowledgements to notifications for the plurality of OIDs.

3. The communication method of claim 1, further comprising:
transmitting, by the SNMP agent, to the SNMP manager, a notification indicating a target event associated with an OID of the plurality of OIDs from a source;
monitoring, by the SNMP agent, for a report of a duplicated event associated with the OID of the plurality of OIDs from the source within a time period; and
in response to receiving the report of the duplicated event within the time period, ignoring the duplicated event.

4. The communication method of claim 1, further comprising:
receiving, by the SNMP agent, from a source, a report of a target event associated with an OID of the plurality of OIDs;
monitoring, by the SNMP agent, for a report of a reverse event associated with the OID of the plurality of OIDs from the source within a time period; and
in response to receiving the report of the reverse event within the time period, ignoring, by the SNMP agent, the target event and the reverse event, and/or
transmitting, by the SNMP agent, to the SNMP manager, a notification indicating a pair of the target event and the reverse event associated with the OID of the plurality of OIDs from the source.

5. The communication method of claim 4, further comprising:
in response to no report of the reverse event within the time period, transmitting, by the SNMP agent, to the SNMP manager, a notification indicating the target event associated with the OID of the plurality of OIDs from the source.

6. The communication method of claim 3, wherein the time period is determined based on a timer used to monitor for a duplicated event and/or a pair of a target event and a reverse event, and the communication method further comprises:
receiving, by the SNMP agent, from the SNMP manager, a configuration for the timer.

7. The communication method of claim 1, wherein the configuration for enabling the acknowledgements to the notifications for the set of OIDs, the indication for allowing the acknowledgements to the notifications for the plurality of OIDs, and/or the configuration for the timer is communicated via management information base, MIB.

8. A communication method, comprising:
selecting, by a Simple Network Management Protocol, SNMP, manager, a set of object identifiers, OIDs, from a plurality of OIDs associated with a SNMP agent; and
transmitting, by the SNMP manager, to the SNMP agent, a configuration for enabling acknowledgements to notifications for the set of OIDs.

9. The communication method of claim 8, further comprising:
receiving, by the SNMP manager, from the SNMP agent, an indication for allowing acknowledgements to notifications for the plurality of OIDs.

10. The communication method of claim 8, further comprising:
transmitting, by the SNMP manager, to the SNMP agent, a configuration for a timer used to monitor for a duplicated event and/or a pair of a target event and a reverse event.

11. The communication method of claim 8, wherein the configuration for enabling the acknowledgements to the notifications for the set of OID, the indication for allowing the acknowledgements to the notifications for the plurality of OIDs, and/or the configuration for the timer is communicated via management information base, MIB.

12. The communication method of claim 8, further comprising:
receiving, by the SNMP manager, from the SNMP agent, a notification indicating a pair of a target event and a reverse event associated with an OID of the plurality of OIDs from a source.

13-24. (canceled)

25. A communication device, comprising:
a processor; and
a memory, the memory containing instructions executable by the processor, whereby the communication device is operative to perform the method according to claim 1.

26. (canceled)
